(19) United States
(12) Patent Application Publication
(10) Pub. No.: US 2026/0145380 A1
(43) Pub. Date: May 28, 2026

(54) THREE-DIMENSIONAL PRINTING WITH VISIBLE LIGHT ABSORBING PIGMENTS

(71) Applicant: PERIDOT PRINT LLC, Palo Alto, CA (US)

(72) Inventors: Vladek Kasperchik, Corvallis, OR (US); Emre Hiro Discekici, San Diego, CA (US); Jayprakash C. Bhatt, Corvallis, OR (US); Ian Pahk, Corvallis, OR (US)

(21) Appl. No.: 19/095,596

(22) Filed: Mar. 31, 2025

Related U.S. Application Data
(60) Provisional application No. 63/724,819, filed on Nov. 25, 2024.

(51) Int. Cl. B29C 64/129; B29C 64/264; B29K 77/00; B29K 423/00; B33Y 10/00; B33Y 70/00

(52) U.S. Cl. CPC B29C 64/129; B29C 64/264; B29K 2077/00; B29K 2423/10; B33Y 10/00; B33Y 70/00

(57) ABSTRACT

A three-dimensional printing kit includes a fusing agent and a polymeric build material composition including a thermoplastic polyamide. The fusing agent includes a visible light absorbing pigment, a plasticizing solvent package, and water. The plasticizing solvent package consist of i) propylene glycol or ii) an aromatic alcohol and a plasticizing solvent that increases water solubility of the aromatic alcohol or iii) propylene glycol, an aromatic alcohol, and a plasticizing solvent that increases water solubility of the aromatic alcohol. A method of using the kit and a 3D printed part are also disclosed.

### CROSS-REFERENCE TO RELATED APPLICATION

This application claims the benefit of U.S. Provisional Application Ser. No. 63/724,819, filed Nov. 25, 2024, the contents of which are incorporated by reference herein in their entirety.

### BACKGROUND

A three-dimensional (3D) printing process is a form of additive manufacturing that can be used to form 3D solid parts, e.g., using a digital model. Some additive 3D printing techniques involve the iterative application of successive layers of materials, such as build material composition(s), fusing agent(s), and the like. In some of these additive 3D printing techniques, at least partial curing, thermal merging/fusing, melting, sintering, etc. of the build material composition(s) may be used to form 3D solid parts, and the mechanism for material coalescence may depend upon the type of build material composition(s) used. For some materials, at least partial melting may be accomplished using heat-assisted extrusion, and for some other materials, curing or fusing may be accomplished using photonic energy sources, such as ultra-violet light or infrared light sources. 3D printing techniques may be used to generate 3D printed parts with various properties, such as parts having mechanical strength for a particular application.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Features of examples of the present disclosure will become apparent by reference to the following detailed description and drawings.

FIG. 1A is a photograph of a coupon formed by layer-by-layer 3D printing using an example of a fusing agent including a Pigment Yellow 74 dispersion. In the photograph shown in FIG. 1A, the coupon exhibits a base color that is yellow.

FIG. 1B is a photograph of the coupon of FIG. 1A after exposure to sunlight irradiation for 109 hours. The coupon shown in FIG. 1B exhibits a yellow color that is substantially the same as the base color of the coupon shown in FIG. 1A (i.e., prior to exposure to the sunlight irradiation).

FIG. 2A is a photograph of a coupon formed by layer-by-layer 3D printing using a comparative fusing agent including Acid Yellow 73 dye. In the photograph shown in FIG. 2A, the coupon exhibits a base color that is dark yellow.

FIG. 2B is a photograph of the coupon of FIG. 2A after exposure to sunlight irradiation for 24 hours. Due to the exposure to the sunlight irradiation, the coupon had completely faded to a whiteish color.

FIG. 3 is a graph depicting the absorbance spectrum, in terms of optical absorbance (arbitrary units, Y axis) vs. wavelength (nm, X axis), of the coupon of FIG. 1A during exposure to sunlight irradiation over a 160-hour time period.

FIG. 4 is a graph depicting the absorbance spectrum, in terms of optical absorbance (arbitrary units, Y axis) vs. wavelength (nm, X axis), of the coupon of FIG. 1B during exposure to sunlight irradiation over a 180-hour time period.

### DETAILED DESCRIPTION

Some 3D printing methods or techniques utilize an energy absorbing substance (e.g., an energy absorber) to pattern a build material composition, thereby forming a patterned region of the build material composition. In these methods or techniques, an entire layer of the build material composition is exposed to radiation, and the patterned region of the build material composition is coalesced and becomes a layer of a 3D printed part. As used herein, the term “coalescence” refers to a process where individual droplets and/or particles of material merge together to form a continuous, solid structure. In this context, coalesced material has merged to form a continuous, solid structure. In the patterned region of build material composition, the energy absorbing substance is capable of at least partially penetrating into voids between the particles of the build material composition and is also capable of spreading onto an exterior surface of particles within the build material composition. The energy absorbing substance is also capable of converting absorbed radiation energy into thermal energy, which may be used to coalesce build material particles that have been patterned with the energy absorbing substance. Coalescing causes the build material particles to join or blend to form a single entity (i.e., a layer of the 3D solid part). Coalescing may involve at least partial thermal merging, melting, binding, and/or some other mechanism that causes the build material composition to form the layer of the 3D solid part.

Some 3D printing methods or techniques, such as Multi Jet Fusion (MJF) technology, utilize a fusing agent that includes the energy absorber to achieve build material coalescence. The energy absorber may be an infrared (IR) energy absorber and the MJF printer may employ IR radiation sources to apply radiation energy to portion(s) of the build material patterned with the fusing agent to achieve the build material coalescence. Near-IR radiation absorbers, such as carbon black or cesium tungsten oxide, have some kind of visible signature, which can compromise the color purity of the 3D printed part. As one example, a fusing agent containing carbon black as the IR energy absorber produces darkly-colored objects (e.g., black, dark grey, or other similar dark color). As another example, a fusing agent containing cesium tungsten oxide as the IR energy absorber produces light blue-colored objects. The color introduced by the fusing agent may be unsuitable for some 3D solid parts.

In some instances, the 3D printer employs near or mid-range ultraviolet (UV) radiation (e.g., 365 nm or less) for fusing build material composition during 3D printing. There are many organic and inorganic UV radiation absorbers that may be used in the fusing agent that have strong UV absorptivity but very little, if any, absorptivity in the visible wavelength range. Such UV absorbers may be referred to as colorless absorbers. In theory, colorless UV absorbers may be combined with a colored dye in the fusing agent formulation, and then used for 3D printing of colored parts. However, the high intensity of the UV radiation needed for achieving fusing may bleach the dye(s) and thus compromise the color quality of the final 3D printed part. Further, exposure of elastomeric powder or fused elastomeric powder to the high intensity UV radiation during 3D printing (e.g., during fusing cycles of the 3D printing method or technique) can damage the molecular structure of the elastomer. This, in turn, could compromise recyclability of the elastomeric powder and adversely affect the mechanical properties of the 3D printed part.

There are a variety of dyes that could be used as radiation absorbers in the fusing agent. Some dyes can absorb UV radiation as mentioned above. Other dyes are visible light absorbers or IR radiation absorbers. Many energy absorbing dyes are in the form of single (non-associated) molecules uniformly distributed in the liquid phase. Dissolved dyes are often efficient energy absorbers, but can be susceptible to photodegradation. For example, after absorbing the electromagnetic radiation, the dye molecule is in an excited state and can easily undergo chemical transformation resulting in absorptivity and color loss.

There are some 3D printing processes that utilize fusing agents having visible light absorbing dye(s) as the energy absorber. Although high quality 3D printed parts can be produced using such dye-based fusing agents, many of the brightly-colored dyes (e.g., Acid Yellow 73) lack ample photostability and exhibit poor resistance to fade. Thus, colored 3D printed parts formed using these types of brightly-colored dyes as the energy absorber tend to lose their brightness or their color when exposed to sunlight or ozone over time. Further, many of these types of brightly-colored dyes degrade over time in solution from oxidation, which can compromise the shelf life of the fusing agent.

In light of foregoing challenges, 3D printing of high performance, colored, polymeric (e.g., elastomeric) parts is not widespread using current printing technologies. This is due to a lack of solutions in the market that offer both high performance and a predetermined cosmetic appearance.

The present disclosure provides a kit for 3D printing and a method for using the kit to produce a colored 3D printed part. The kit includes a fusing agent containing visible light absorbing pigment(s) that absorb light within the visible wavelength range, i.e., from about 400 nm to about 700 nm. The visible light absorbing pigment(s) do not absorb short UV wavelengths (UV-C), and thus the build material composition is not exposed to such wavelengths during 3D printing. Exposure to UV-C radiation tends to break down the molecular structure of the elastomeric build material, leading to color fading, material degradation, and possibly structurally change the elastomer. Avoidance of these wavelength can improve the recyclability of the non-patterned build material composition, and lead to the production of mechanically stronger 3D printed parts. Moreover, the visible light absorbing pigment(s) may exhibit superior oxidative fade resistance, thus prolonging the shelf life of the fusing agent.

The kit and method can be used to generate colored 3D printed parts using current printing technology that employs visible light source(s) (e.g., visible light emitting diodes (LEDs), etc.) to fuse polymeric (e.g., elastomeric) build material particles. The visible light absorbing pigment(s) in the fusing agent operates as both an energy absorber and a colorant. As demonstrated in the Examples section below, it has been found that 3D printed parts formed utilizing the fusing agent of the present disclosure can be directly colored, via the visible light absorbing pigment(s), during the 3D printing process. It has also been found that the colored 3D printed parts exhibit excellent lightfastness (i.e., fade resistance when exposed to light), leading to a more consistent color appearance throughout the life of the part.

Further, the presence of the solvent(s) in the fusing of the present disclosure helps to modify the thermal properties of the build material such that onset of melting (and in turn the melt temperature) of the build material is reduced. In particular, the use of plasticizing solvent(s) facilitates a melt temperature reduction of the polymer. This, in turn, facilitates improved fusing between build material layers. As such, use of the fusing agent during printing can thereby improve mechanical properties of the 3D printed part, in addition to enabling a wide variety of colors to be added to the 3D printed part during its fabrication.

In one example, the kit for 3D printing, as disclosed herein, comprises a) a fusing agent including: a visible light absorbing pigment present in an amount ranging from about 0.1 wt % active to about 10 wt % active, based on a total weight of the fusing agent, a plasticizing solvent package consisting of i) from about 40 wt % active to 60 wt % active of propylene glycol, based on the total weight of the fusing agent or ii) from about 1 wt % active to about 20 wt % active of an aromatic alcohol and from about 5 wt % active to 50 wt % active of a plasticizing solvent that increases water solubility of the aromatic alcohol, based on the total weight of the fusing agent or iii) from about 10 wt % active to about 30 wt % active of propylene glycol, from about 5 wt % active to about 20 wt % active of an aromatic alcohol, and from about 5 wt % active to 50 wt % active, based on the total weight of the fusing agent, of a plasticizing solvent that increases water solubility of the aromatic alcohol, and a balance of water; and b) a polymeric build material composition including thermoplastic polyamide.

Also disclosed herein is a method of using the kit for 3D printing. The method includes generating a lightfast 3D printed part containing multiple fused layers, each of the fused layers being formed by: forming a layer of the polymeric build material composition, based on a 3D object model, selectively applying the fusing agent to the layer, and exposing the layer to visible light.

A 3D printed part is also disclosed herein. The 3D printed part comprises coalesced thermoplastic polyamide, a residual amount of a plasticizing solvent package present in the coalesced thermoplastic polyamide, and a pigment embedded in the coalesced thermoplastic polyamide, the pigment being selected from the group consisting of an anthraquinone, a phthalocyanine blue, phthalocyanine green, an azo, a quinophthalone, a perylene, a quinacridone, and a (thio) indigoid.

Throughout this disclosure, a weight percentage that is referred to as “wt % active” refers to the weight percentage of the active component in a formulation. This is calculated by taking the mass of the active component and dividing it by the total mass of the formulation, then multiplying by 100 to get a percentage. Essentially, it represents the concentration of the active ingredient in a formulation, excluding any other non-active components present in the formulation. As an illustration, particles of an energy absorber, such as pigment particles, may be present in a water-based formulation (e.g., a stock solution or dispersion) before being incorporated into a 3D printing fusing agent. In this example, the wt % active of the energy absorber accounts for the loading (as a weight percent) of the energy absorber solids that are present in the 3D fusing agent, and does not account for the weight of other components (e.g., water, etc.) introduced with the energy absorber into the fusing agent.

Additionally, throughout this disclosure, the terms “3D printing fusing agent,” “3D fusing agent,” and “fusing agent” are used interchangeably herein, and the terms “3D solid part”, “3D printed part”, “3D printed object”, “3D part”, and “3D object” are used interchangeably herein.

### Kit for 3D Printing

In an example, the kit for 3D printing includes the fusing agent and the polymeric build material composition. In another example, the kit further includes a detailing agent. Details of the fusing agent, the detailing agent, and the polymeric build material composition are set forth below.

It should be understood that the fusing agent and the polymeric build material composition (and the detailing agent, when included) of the kit may be maintained or contained separately until used together in a 3D printing method described in detail below. The fusing agent and/or the polymeric build material composition (and/or the detailing agent, when included) may each be contained in a container prior to and during 3D printing, but may be combined together during 3D printing. The containers can be any type of vessel (e.g., reservoir, box, or receptacle) made of any material.

### Fusing Agent

In an example, the fusing agent of the present disclosure includes a visible light absorbing pigment, a plasticizing solvent package, and water. In another example, the plasticizing solvent package and water are part of a liquid vehicle. In this example, the fusing agent includes a visible light absorbing pigment and the liquid vehicle, where the liquid vehicle includes the plasticizing solvent package and water. In still another example, the liquid vehicle includes the plasticizing solvent package, water, and, in some instances, additive(s) (e.g., a surfactant, a dispersant, etc.). In yet another example, the fusing agent consists of a visible light absorbing pigment and the liquid vehicle, where the liquid vehicle consists of the plasticizing solvent package, water, and a surfactant. In still a further example, the fusing agent consists of a visible light absorbing pigment and the liquid vehicle, where the liquid vehicle consists of the plasticizing solvent package, water, a surfactant, and a dispersant. As will be described herein, in any of these examples, the visible light absorbing pigment may initially be part of a dispersion. In these instances, the fusing agent includes the components of the pigment dispersion.

The visible light absorbing pigment may be selected from any pigment that is capable of absorbing electromagnetic radiation at wavelengths falling within the visible light spectrum (i.e., wavelengths ranging from about 400 nm to about 700 nm). The visible light absorbing pigment is thereby considered to be an energy absorber in the examples of the fusing agent described herein. The visible light absorbing pigment particles are dye-like colorant molecules that aggregate together and are insoluble in the liquid vehicle of the fusing agent. Unlike dye-based radiation absorbers, colorant molecules in surface layers of the pigment particle can absorb electromagnetic radiation and then quickly dissipate energy to neighboring colorant molecules without changing the molecular structure of the pigment and losing coloration.

In an example, the visible light absorbing pigment of the fusing agent disclosed herein is selected from the group consisting of an anthraquinone, a phthalocyanine blue, phthalocyanine green, an azo, a quinophthalone, a perylene, a quinacridone, and a (thio) indigoid. Self-dispersed or non-self-dispersed forms of each of these pigments may be used.

Examples of anthraquinones that may be used as the visible light absorbing pigment include Pigment Red (PR) 43, PR 194 (perinone red), PR 216 (brominated pyrathrone red), PR 226 (pyranthrone red), or combinations thereof. Examples of phthalocyanine blues that may be used include copper phthalocyanine blue and derivatives thereof (e.g., PB 15). Examples of suitable azo pigments that may be used include Pigment Yellow (PY) 74, PY 117, or combinations thereof. An example of a quinophthalone that may be used is PY 138. Examples of perylene pigment that may be used include PR 123 (vermillion), PR 149 (scarlet), PR 179 (maroon), PR 190 (red), PR 189 (yellow shade red), PR 224, or combinations thereof. Examples of quinacridones that may be used include pigment orange (PO) 48, PO 49, PR 122, PR 192, PR 202, PR 206, PR 207, PR 209, pigment violet (PV) 19, PV 42, or combinations thereof. Examples of (thio) indigoids that may be used include PR 86, PR 87, PR 88, PR 181, PR 198, PV 36, PV 38, or combinations thereof. Examples of other suitable colored pigments are described in Colour Index, 3rd edition (The Society of Dyers and Cikiyrusts, 1982).

In an example, the visible light absorbing pigment is selected from the group consisting of an azo and a quinophthalone. When the azo pigment is used, the azo is PY 74 or PY 117. When, however, the quinophthalone is used, the quinophthalone is PY 138.

In another example, the visible light absorbing pigment is a phthalocyanine blue, where the phthalocyanine blue is copper phthalocyanine blue or a derivative thereof.

In still another example, the visible light absorbing pigment is selected from the group consisting of an anthraquinone, a perylene, a quinacridone, and a (thio) indigoid. When the visible light absorbing pigment is the anthraquinone, the anthraquinone is selected from the group consisting of Pigment Red (PR) 43, PR 194, PR 216, PR 226, and combinations thereof. When the visible light absorbing pigment is the perylene, the perylene is PR 123, PR 149, PR 179, PR 190, PR 189, PR 224, and combinations thereof. When the visible light absorbing pigment is the quinacridone, the quinacridone is selected from the group consisting of pigment orange (PO) 48, PO 49, PR 122, PR 192, PR 202, PR 206, PR 207, PR 209, pigment violet (PV) 19, PV 42, and combinations thereof. When the visible light absorbing pigment is the (thio) indigoid, the (thio) indigoid is PR86, PR87, PR88, PR181, PR198, PV36, PV38, or combinations thereof.

As mentioned, the visible light absorbing pigment may be initially present in a dispersion that includes the visible light absorbing pigment dispersed in a solvent. In an example, the solvent of the dispersion is water. The visible light absorbing pigment dispersion could include, in some instances, organic co-solvent(s) in addition to the water. The visible light absorbing pigment dispersion may further include a dispersant. In a particular example, the visible light absorbing pigment dispersion includes the visible light absorbing pigment and water.

Some of the visible light absorbing pigments set forth herein are non-self-dispersing pigments, and thus the dispersion includes a dispersant to aid in the dispersability of the visible light absorbing pigment. The dispersant may also aid in ink jettability of the fusing agent. The dispersant may be a small molecule surfactant or polymer. Examples of suitable dispersants include a water-soluble acrylic acid polymer (e.g., CARBOSPERSE® K7028 available from Lubrizol), water-soluble styrene-acrylic acid copolymers/resins (e.g., JONCRYL® 296, JONCRYL® 671, JONCRYL® 678, JONCRYL® 680, JONCRYL® 683, JONCRYL® 690, etc. available from BASF Corp.), a high molecular weight block copolymer with pigment affinic groups (e.g., DISPERBYK®-190 available BYK Additives and Instruments), and water-soluble styrene-maleic anhydride copolymers/resins. In one particular example, the dispersion, and thus the fusing agent formed with the dispersion, includes a styrene acrylic dispersant. The styrene acrylic dispersant may be present in the dispersion in an amount ranging from about 0.1% to about 0.5%, based on the total mass of the pigment in the dispersion. The amount that is incorporated in the fusing agent will depend upon the amount in the dispersion, and the amount of dispersion included in the fusing agent.

Examples of suitable organic co-solvents that may be present in the pigment dispersion include tetraethylene glycol (TEG) and/or glyercol. In the dispersion, the pigment to co-solvent weight ratio may be 1:1 to 5:1.

To form the fusing agent when the visible light absorbing pigment is part of a dispersion, the visible light absorbing pigment dispersion is mixed with the liquid vehicle. It is to be understood that the liquid components of the visible light absorbing pigment dispersion become part of the fusing agent.

The amount of the visible light absorbing pigment in the dispersion may range from about 10 wt % to about 70 wt %, based on the total weight of the dispersion. In a particular example, the visible light absorbing pigment dispersion includes about 13.5 wt % active of the visible light absorbing pigment. The dispersion may be incorporated into the liquid vehicle so that the amount of the visible light absorbing pigment that is present in the fusing agent (in terms of wt % active pigment) conforms to any of the suitable ranges set forth herein. In one example, the visible light absorbing pigment dispersion is incorporated into the liquid vehicle so that the visible light absorbing pigment is present in an active amount that is suitable for the inkjet printing architecture that is to be used for the fusing agent. In some examples, the visible light absorbing pigment dispersion is incorporated into the liquid vehicle so that the visible light absorbing pigment is present in an amount ranging from about 0.1 wt % active to about 10 wt % active, based on a total weight of the fusing agent. In other examples, the visible light absorbing pigment dispersion is incorporated into the liquid vehicle so that the visible light absorbing pigment is present in an amount ranging from about 0.2 wt % active to about 5 wt % active, based on a total weight of the fusing agent. In one example, the visible light absorbing pigment dispersion is incorporated into the liquid vehicle so that the visible light absorbing pigment is present in an amount of about 0.5 wt % active to about 2.0 wt % active, based on a total weight of the fusing agent. In still another example, the visible light absorbing pigment dispersion is incorporated into the liquid vehicle so that the visible light absorbing pigment is present in an amount of about 3.0 wt % active to about 4.0 wt % active, based on a total weight of the fusing agent.

A solid form of the visible light absorbing pigment may alternatively be introduced directly into the liquid vehicle of the fusing agent (i.e., without initially being present in a dispersion). To form the fusing agent when the visible light absorbing pigment is not part of a dispersion, the solid visible light absorbing pigment is mixed with the liquid vehicle. In an example, the total amount of visible light absorbing pigment ranges from about 0.1 wt % to about 6 wt %, based on the total weight of the fusing agent.

In such instances, the dispersant described herein may be added to the liquid vehicle along with the solid form of the visible light absorbing pigment, for example, if the pigment is not a self-dispersing pigment. The added dispersant helps to disperse the visible light absorbing pigment in the liquid vehicle. When added separately, the dispersant may be added in any suitable amount per the range set forth herein with respect to the mass of the pigment.

The fusing agent further includes a plasticizing solvent package. As used herein, the term “plasticizing solvent package” refers to co-solvent(s) other than water that is/are present in the fusing agent, where the “plasticizing solvent package” includes a plasticizing solvent. It should be understood that all of the co-solvents of the plasticizing solvent package are plasticizing solvents. The plasticizing solvents can be combined together to form the plasticizing solvent package prior to being combined or mixed with other component(s) of the fusing agent (e.g., water, pigment, etc.). This may be useful when the aromatic alcohol is included in the solvent package as the other solvent in the package aids in bringing the aromatic alcohol into solution as described below. Alternatively, each of the plasticizing solvents could be incorporated into the fusing agent separately. The term “plasticizing solvent” refers to a low-volatile solvent that interacts with and increases the flexibility of (i.e., plasticizes) the build material polymer. This may generate a more pliable surface that improves pigment penetration. It is to be understood that throughout this disclosure, the terms “solvent” and “co-solvent” are used interchangeably.

In one example, the plasticizing solvent package consists of propylene glycol (PG or 1,2-propanediol). In this example, the plasticizing solvent package consists of a single plasticizing solvent (i.e., propylene glycol) and is free or devoid of any other solvents, including any other additional plasticizing solvent. The propylene glycol is present in the fusing agent in an amount ranging from about 40 wt % active to about 60 wt % active, based on the total weight of the fusing agent. In another example, the propylene glycol is present in the fusing agent in an amount ranging from about 45 wt % active to about 55 wt % active, based on the total weight of the fusing agent. In still another example, the propylene glycol is present in the fusing agent in an amount ranging from about 48 wt % active to about 52 wt % active, based on the total weight of the fusing agent. In a particular example, the propylene glycol is present in the fusing agent in an amount of about 50 wt % active.

In an alternative example, the plasticizing solvent package consists of an aromatic alcohol and a plasticizing solvent that increases the water solubility of the aromatic alcohol. The aromatic alcohol can be benzyl alcohol (which has the formula C₆H₅CH₂OH) or 2-phenoxyethanol. The aromatic alcohol is present in the fusing agent in an amount ranging from about 1 wt % active to about 20 wt % active, based on the total weight of the fusing agent. In another example, the aromatic alcohol is present in the fusing agent in an amount ranging from about 5 wt % active to about 15 wt % active, based on the total weight of the fusing agent. In still another example, the aromatic alcohol is present in the fusing agent in an amount ranging from about 8 wt % active to about 12 wt % active, based on the total weight of the fusing agent. It is noted that at concentrations higher than 20 wt % active, the aromatic alcohol could adversely affect print reliability.

The plasticizing solvent in this example is any plasticizing solvent that is a solvent for the aromatic alcohol, and thus will suitably increase the water solubility of the aromatic alcohol. The solvent that is selected may have a higher solubility for the aromatic alcohol than water. In other words, the plasticizing solvent assists in bringing the aromatic alcohol into solution. The inclusion of such a solvent enables the fusing agent to be prepared with a predetermined amount of aromatic alcohol that is suitable for solubilizing and plasticizing the build material during 3D printing.

Plasticizing solvents that are solvents for some aromatic alcohols, such as benzyl alcohol, include water-soluble or water-miscible co-solvents, such as 2-pyrrolidone, 1-(2-hydroxyethyl)-2-pyrrolidone (HE2P), glycerol, isopropylidene glycerol (IPG), 2-methyl-1,3-propanediol, 1,2-butane diol, diethylene glycol, triethylene glycol, tetraethylene glycol, dipropylene glycol, diethylene glycol butyl ether, other glycol ethers, poly(ethylene glycol) 300, and combinations thereof. In an example, the plasticizing solvent is selected from the group consisting of 1-(2-hydroxyethyl)-2-pyrrolidone (HE2P), isopropylidene glycerol (IPG), polyethylene glycol (PEG) 300, and glycerol. In a particular example, the plasticizing solvent is 1-(2-hydroxyethyl)-2-pyrrolidone.

The amount of solvent for the aromatic alcohol that is included may depend, in part, upon the amount of aromatic alcohol that is included in the fusing agent. In an example, the benzyl alcohol and the solvent are present (in the fusing agent) in a weight ratio ranging from about 1:50 to about 2:3. In an example, the benzyl alcohol and the solvent are present in a weight ratio of 1:3.

The plasticizing solvent for the aromatic alcohol (e.g., benzyl alcohol) in the current example of the plasticizing solvent package may be present in the fusing agent in an amount ranging from about 5 wt % active to about 50 wt % active, based on the total weight of the fusing agent. In another example, the plasticizing solvent in the current example of the plasticizing solvent package is present in the fusing agent in an amount ranging from about 35 wt % active to about 45 wt % active, based on the total weight of the fusing agent.

In one specific example, the solvent package consists of the aromatic alcohol and the plasticizing solvent; the aromatic alcohol is selected from the group consisting of benzyl alcohol and 2-phenoxyethanol; and the plasticizing solvent is selected from the group consisting of 1-(2-hydroxyethyl)-2-pyrrolidone (HE2P), isopropylidene glycerol (IPG), poly(ethylene glycol) 300, and glycerol.

In another alternative example, the plasticizing solvent package consists of propylene glycol, an aromatic alcohol, and the plasticizing solvent. Aromatic alcohols and plasticizing solvents that may suitably be used for this example of the plasticizing solvent package are the same as described in the alternate example of the solvent package above. In one specific example, the solvent package consists of propylene glycol, the aromatic alcohol, and the plasticizing solvent; the aromatic alcohol is selected from the group consisting of benzyl alcohol and 2-phenoxyethanol; and the plasticizing solvent is selected from the group consisting of 1-(2-hydroxyethyl)-2-pyrrolidone (HE2P), isopropylidene glycerol (IPG), poly (ethylene glycol) 300, and glycerol.

In this example of the plasticizing solvent package, the propylene glycol is present in an amount ranging from about 10 wt % active to about 30 wt % active, or from about 15 wt % active to about 25 wt % active, or from about 18 wt % active to about 22 wt % active, based on the total weight of the fusing agent. The aromatic alcohol is present in the fusing agent in an amount ranging from about 5 wt % active to about 20 wt % active, or from about 10 wt % active to about 20 wt % active, or from about 12 wt % active to about 16 wt % active, based on the total weight of the fusing agent. The plasticizing solvent is present in the fusing agent in an amount ranging from about 5 wt % active to about 50 wt % active, or 30 wt % active to about 40 wt % active, based on the total weight of the fusing agent. It is to be understood that the maximum total amount of the solvent(s) present in the fusing agent is 75 wt % active. In other words, the total amount of the solvent or solvents present in the fusing agent cannot exceed 75 wt % active. At concentrations greater than 20 wt % active, the aromatic alcohol could adversely affect print reliability.

In addition to the plasticizing solvent package described herein, the fusing agent also includes water and, in some instances, additives. These liquid components make up a liquid vehicle of the fusing agent. Examples of the additives include surfactants, antimicrobial agents, chelating agents, anti-kogation agents, buffers, and combinations thereof. In an example, the fusing agent consists of the plasticizing solvent package, water, and the visible light absorbing pigment. In another example, the fusing agent consists of the plasticizing solvent package, water, the visible light absorbing pigment (and any components of the dispersion, if used), and a surfactant.

The fusing agent may further include a surfactant as the additive. Examples of surfactants that may be used for the fusing agent include non-ionic or anionic surfactants. Some example surfactants include alkyl polyethylene oxides, alkyl phenyl polyethylene oxides, polyethylene oxide block copolymers, acetylenic polyethylene oxides, polyethylene oxide (di) esters, polyethylene oxide amines, dimethicone copolyols, substituted amine oxides, fluorosurfactants, and the like. Some examples of these surfactants include a self-emulsifiable, non-ionic wetting agent based on acetylenic diol chemistry (e.g., SURFYNOL® SEF from Evonik Degussa), a non-ionic fluorosurfactant (e.g., CAPSTONE® fluorosurfactants, such as CAPSTONE® FS-35, from Chemours), an ethoxylated low-foam wetting agent (e.g., SURFYNOL® 440 or SURFYNOL® CT-111 from Evonik Degussa), an ethoxylated wetting agent and molecular defoamer (e.g., SURFYNOL® 420 from Evonik Degussa), non-ionic wetting agents and molecular defoamers (e.g., SURFYNOL® 104E from Evonik Degussa), and/or water-soluble, non-ionic surfactants (e.g., TERGITOL™ TMN-6, TERGITOL™ 15-S-7, or TERGITOL™ 15-S-9 (a secondary alcohol ethoxylate) from The Dow Chemical Company or TEGO® Wet 510 (organic surfactant) available from Evonik Degussa). Yet another anionic surfactant includes alkyldiphenyloxide disulfonate (e.g., the DOWFAX™ series, such a 2A1, 3B2, 8390, C6L, C10L, and 30599, from The Dow Chemical Company).

Whether a single surfactant is used, or a combination of surfactants is used, the total amount of surfactant(s) ranges from about 0.01 wt % active to about 2 wt % active, based on the total weight of the fusing agent. In another example, the total amount of surfactant(s) present in the fusing agent ranges from about 0.05 wt % active to about 1 wt % active, based on the total weight of the fusing agent. In another example, the total amount of surfactant(s) used is about 0.70 wt % active, based on the total weight of the fusing agent.

Antimicrobial agents are also known as biocides and/or fungicides. Examples of suitable antimicrobial agents that may be used as an additive in the fusing agent include NUOSEPT® (Ashland Inc.), UCARCIDE™ or KORDEK™ or ROCIMA™ (The Dow Chemical Company), PROXEL® (Arch Chemicals) series, ACTICIDE® B20 and ACTICIDE® M20 and ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant Int. Ltd.), blends of 5-chloro-2-methyl-4-isothiazolin-3-one (CIT or CMIT) and MIT under the tradename KATHON™ (The Dow Chemical Company), and combinations thereof.

In an example, the total amount of antimicrobial agent(s) ranges from about 0.01 wt % active to about 0.05 wt % active, based on the total weight of the fusing agent.

Chelating agents (or sequestering agents) may be included in the fusing agent to eliminate the deleterious effects of heavy metal impurities. In an example, the chelating agent is selected from the group consisting of methylglycinediacetic acid, trisodium salt; 4,5-dihydroxy-1,3-benzenedisulfonic acid disodium salt monohydrate; ethylenediaminetetraacetic acid (EDTA); hexamethylenediamine tetra (methylene phosphonic acid), potassium salt; and combinations thereof. Methylglycinediacetic acid, trisodium salt (Na3MGDA) is commercially available as TRILON® M from BASF Corp. 4,5-dihydroxy-1,3-benzenedisulfonic acid disodium salt monohydrate is commercially available as TIRON™ monohydrate. Hexamethylenediamine tetra (methylene phosphonic acid), potassium salt is commercially available as DEQUEST® 2054 from Italmatch Chemicals.

Whether a single chelating agent is used or a combination of chelating agents is used, the total amount of chelating agent(s) may range from greater than 0 wt % active to about 0.5 wt % active, based on the total weight of the fusing agent.

In some examples, the additive in the fusing agent is an anti-kogation agent. “Kogation” refers to the deposit of dried printing liquid (e.g., the fusing agent) on a heating element of a thermal inkjet printhead. Anti-kogation agent(s) is/are included to assist in preventing the buildup of kogation. Examples of anti-kogation agents include oleth-3-phosphate (commercially available as CRODAFOS™ 03A or CRODAFOS™ N-3A) or dextran 500,000. Other examples of the anti-kogation agents include CRODAFOS™ HCE (a phosphate-ester from Croda Int.), CRODAFOS® O10A (oleth-10-phosphate from Croda Int.), and DISPERSOGEN® LFH (a polymeric dispersing agent with aromatic anchoring groups, acid form, anionic, from Clariant Int. Ltd.), etc. It is to be understood that any combination of the anti-kogation agents listed may be used.

In an example, the total amount of anti-kogation agent(s) may range from greater than 0 wt % active to about 0.5 wt % active, based on the total weight of the fusing agent.

The liquid vehicle may also include a buffer. Examples of suitable buffers include tris (Hydroxymethyl)aminomethane based buffers, such as TRIS and TRIZMA, and (4-(2-hydroxyethyl)-1-piperazineethanesulfonic acid) (HEPES).

In an example, the total amount of buffer(s) may range from 0.01 wt % active to about 1 wt % active, based on the total weight of the fusing agent.

In addition to the plasticizing solvent package, the liquid vehicle of the fusing agent further includes water. The water generally makes up a balance of the fusing agent, relative to the other components included in the fusing agent (e.g., the plasticizing solvent package, visible light absorbing pigment, and any additives included in the fusing agent). The amount of water included in the fusing agent depends upon the amount of each of the other components included in the fusing agent. In an example, the amount of water present in the fusing agent ranges from 25 wt % to about 70 wt %, based on the total weight of the fusing agent. In another example, the amount of water preset in the fusing agent ranges from 30 wt % to 66 wt %, based on the total weight of the fusing agent. The water may be pure water, deionized water (DI water), distilled water, or any other suitable form of water.

Table 1 below illustrates an example formulation of the fusing agent that may be used:

TABLE 1

| Component | Wt % |
|---|---|
| Plasticizing Solvent | 42.0 |
| Aromatic Alcohol | 13.0 |
| Visible Light Absorbing Pigment | 1.0 |
| Surfactant | 0.7 |
| Water | Balance |

Any example of the fusing agent set forth herein can be used in a 3D printing method, which is applied to a build material composition. The fusing agent may be used in the 3D printing method with or without a detailing agent. The detailing agent and the build material composition are described further below.

### Detailing Agent

The detailing agent may include a surfactant, a co-solvent, and a balance of water. In an example, the detailing agent consists of these components and no other components. In another example, the detailing agent further includes additional components, such as anti-kogation agent(s), antimicrobial agent(s), and/or chelating agent(s), each of which is described above in reference to the fusing agent. The balance of the detailing agent is water. As such, the amount of water may vary depending upon the amounts of the other components that are included in the detailing agent.

Suitable surfactant(s) for the detailing agent include non-ionic or anionic surfactants. It may be suitable to select a surfactant that does not react with the aromatic alcohol if used in the fusing agent. Some example surfactants include alkyl polyethylene oxides, alkyl phenyl polyethylene oxides, polyethylene oxide block copolymers, acetylenic polyethylene oxides, polyethylene oxide (di) esters, polyethylene oxide amines, dimethicone copolyols, substituted amine oxides, fluorosurfactants, and the like. Some specific examples include a self-emulsifiable, non-ionic wetting agent based on acetylenic diol chemistry (e.g., SURFYNOL® SEF from Evonik Degussa), a non-ionic fluorosurfactant (e.g., CAPSTONE® fluorosurfactants, such as CAPSTONE® FS-35, from Chemours), an ethoxylated low-foam wetting agent (e.g., SURFYNOL® 440 or SURFYNOL® CT-111 from Evonik Degussa), an ethoxylated wetting agent and molecular defoamer (e.g., SURFYNOL® 420 from Evonik Degussa), non-ionic wetting agents and molecular defoamers (e.g., SURFYNOL® 104E from Evonik Degussa), and/or water-soluble, non-ionic surfactants (e.g., TERGITOL™ TMN-6, TERGITOL™ 15-S-7, or TERGITOL™ 15-S-9 (a secondary alcohol ethoxylate) from The Dow Chemical Company or TEGO® Wet 510 (organic surfactant) available from Evonik Degussa). Yet another suitable (anionic) surfactant includes alkyldiphenyloxide disulfonate (e.g., the DOWFAX™ series, such a 2A1, 3B2, 8390, C6L, C10L, and 30599, from The Dow Chemical Company).

The detailing agent may include co-solvent(s). Classes of water soluble or water miscible organic co-solvents that may be used in the detailing agent include aliphatic alcohols, aromatic alcohols, diols, glycol ethers, polyglycol ethers, lactams, formamides (substituted and unsubstituted), acetamides (substituted and unsubstituted), glycols, and long chain alcohols. Examples of these co-solvents include primary aliphatic alcohols, secondary aliphatic alcohols, 1,2-alcohols, 1,3-alcohols, 1,5-alcohols, other diols (e.g., 2-methyl-1,3-propanediol, etc.), ethylene glycol alkyl ethers, propylene glycol alkyl ethers, higher homologs (C6-C12) of polyethylene glycol alkyl ethers, triethylene glycol, tetraethylene glycol, tripropylene glycol methyl ether, N-alkyl caprolactams, unsubstituted caprolactams, 1-methyl-2-pyrrolidone, 2-pyrrolidone, and the like. Other examples of suitable organic co-solvents include dimethyl sulfoxide (DMSO), isopropyl alcohol, ethanol, pentanol, acetone, or the like.

The examples of the detailing agent disclosed herein do not include a colorant. As such, the detailing agent may be colorless. As used herein, “colorless” means that the detailing agent is achromatic and does not include a colorant. The colorless detailing agent, in combination with the fusing agent, may be used to generate 3D object layer(s)/object(s) exhibiting a color.

### Build Material Composition

The fusing agent (and the detailing agent if used) of the present disclosure may be suitable for printing on a polymeric build material composition (referred to interchangeably herein as the “build material composition”). The polymeric materials for the polymeric build material composition include thermoplastic polyamides. Examples of suitable thermoplastic polyamides include polyamide-11 (PA 11/nylon 11), polyamide-12 (PA 12/nylon 12), polyamide-6 (PA 6/nylon 6), polyamide-8 (PA 8/nylon 8), polyamide-9 (PA 9/nylon 9), polyamide-66 (PA 66/nylon 66), polyamide-612 (PA 612/nylon 612), polyamide-812 (PA 812/nylon 812), polyamide-912 (PA 912/nylon 912), etc.), a thermoplastic polyamide (TPA), and combinations thereof.

The polymeric material may be made up of similarly sized particles and/or differently sized particles. In an example, the average particle size of the polymeric material ranges from about 2 μm to about 225 μm. In another example, the average particle size of the polymeric material ranges from about 10 μm to about 130 μm. The term “average particle size,” as used herein, refers to a volume-weighted mean diameter of a particle distribution.

In some examples, in addition to the polymeric material, the build material composition may include an antioxidant, an antistatic agent, a flow aid, or a combination thereof. In an example, the build material composition is free of a whitener. It has been found that suitable color fidelity can be achieved using the fusing agent and a build material composition that does not include a whitener. However, it is to be understood that the fusing agent may also be used with a build material composition that does contain a whitener. The presence of the whitener can increase the opacity of the build material composition, providing a canvas upon which to dispense the fusing agent.

While several examples of the build material composition additives are provided, it is to be understood that these additives are selected to be thermally stable (i.e., will not decompose) at the 3D printing temperatures.

Antioxidant(s) may be added to the build material composition to prevent or slow molecular weight decreases of the polymeric material and/or to prevent or slow discoloration (e.g., yellowing) by preventing or slowing oxidation of the polymeric material. In some examples, the polymeric material may discolor upon reacting with oxygen, and this discoloration may contribute to the discoloration of the build material composition. The antioxidant may be selected to minimize discoloration. In some examples, the antioxidant may be a radical scavenger. In these examples, the antioxidant may include IRGANOX® 1098 (benzenepropanamide, N,N′-1,6-hexanediylbis (3,5-bis(1,1-dimethylethyl)-4-hydroxy)), IRGANOX® 254 (a mixture of 40% triethylene glycol bis(3-tert-butyl-4-hydroxy-5-methylphenyl), polyvinyl alcohol and deionized water), and/or other sterically hindered phenols. In other examples, the antioxidant may include a phosphite and/or an organic sulfide (e.g., a thioester). The antioxidant may be in the form of fine particles (e.g., having an average particle size of 5 μm or less) that are dry blended with the polymeric material.

In an example, the antioxidant may be included in the build material composition in an amount ranging from about 0.01 wt % to about 5 wt %, based on the total weight of the build material composition. In other examples, the antioxidant may be included in the build material composition in an amount ranging from about 0.01 wt % to about 2 wt % or from about 0.2 wt % to about 1 wt %, based on the total weight of the build material composition.

Antistatic agent(s) may be added to the polymeric build material composition to suppress tribo-charging. Examples of suitable antistatic agents include aliphatic amines (which may be ethoxylated), aliphatic amides, quaternary ammonium salts (e.g., behentrimonium chloride or cocamidopropyl betaine), esters of phosphoric acid, polyethylene glycolesters, or polyols. Some suitable commercially available antistatic agents include HOSTASTAT® FA 38 (natural based ethoxylated alkylamine), HOSTASTAT® FE2 (fatty acid ester), and HOSTASTAT® HS 1 (alkane sulfonate), each of which is available from Clariant Int. Ltd.).

In an example, the antistatic agent is added in an amount ranging from greater than 0 wt % to less than 5 wt %, based upon the total weight of the build material composition.

Flow aid(s) may be added to improve the coating flowability of the polymeric build material composition. Flow aids may be particularly beneficial when the polymeric material in the build material composition has an average particle size less than 25 μm. The flow aid improves the flowability of the build material composition by reducing the friction, the lateral drag, and the tribocharge buildup (by increasing the particle conductivity). Examples of suitable flow aids include aluminum oxide (Al2O₃), tricalcium phosphate (E341), powdered cellulose (E460 (ii)), magnesium stearate (E470b), sodium bicarbonate (E500), sodium ferrocyanide (E535), potassium ferrocyanide (E536), calcium ferrocyanide (E538), bone phosphate (E542), sodium silicate (E550), silicon dioxide (E551), calcium silicate (E552), magnesium trisilicate (E553a), talcum powder (E553b), sodium aluminosilicate (E554), potassium aluminum silicate (E555), calcium aluminosilicate (E556), bentonite (E558), aluminum silicate (E559), stearic acid (E570), and polydimethylsiloxane (E900).

In an example, the flow aid is added in an amount ranging from greater than 0 wt % to less than 5 wt %, based upon the total weight of the build material composition.

Whitener(s) may be added to the build material composition in certain examples to bring the L* of the build material composition closer to 100 (white). It is to be understood, however, that some examples of the build material composition do not include the whitener. Examples of suitable whiteners include titanium dioxide (TiO₂), zinc oxide (ZnO), calcium carbonate (CaCO₃), zirconium dioxide (ZrO₂), aluminum oxide (Al2O₃), silicon dioxide (SiO₂), boron nitride (BN), barium sulfate, and combinations thereof. In some examples, a stilbene derivative may be used as the whitener and a brightener. In these examples, the temperature(s) of the 3D printing process may be selected so that the stilbene derivative remains stable (i.e., the 3D printing temperature does not thermally decompose the stilbene derivative).

When included, any example of the whitener may be included in the build material composition in an amount ranging from greater than 0 wt % to about 10 wt %, based on the total weight of the build material composition.

### 3D Printing Method

An example of a 3D printing method utilizing the fusing agent is described in detail below. Prior to execution of the method, it is to be understood that a controller may access data stored in a data store pertaining to a 3D solid part (or 3D printed object) that is to be made/printed. For example, the controller may determine the number of layers of a build material composition that are to be formed, the locations at which the fusing agent (and the detailing agent, when used) is to be deposited on each of the respective layers, etc.

The method includes generating a lightfast 3D printed part containing multiple fused layers. As used herein, a “lightfast 3D printed part” is a 3D part formed by the layer-by-layer 3D printing method described in detail below, where the 3D printed part is resistant to fading (i.e., is not prone to discoloration or color loss) when exposed to ultraviolet and/or visible light. The lightfast 3D printed part is generated by forming a layer of the polymeric build material composition, based on a 3D object model, selectively applying the fusing agent to the layer, and exposing the layer to visible light. These method steps are described in detail below. It should be understood that the fusing agent used in the method may be any of the respective formulations described above. In an example, the method further includes, based on the 3D object model, applying the detailing agent onto another portion of the build material layer.

In an example method, the build material composition is applied to form a build material layer on a build area platform. It is to be understood that any of the polymeric build materials described herein may be used in the method as the build material composition. In a particular example, the polymeric build material composition used in the example method includes a thermoplastic polyamide. A printing system may be used to apply the build material composition. The printing system may include the build area platform, a build material supply containing the build material composition, and a build material distributor.

The build area platform receives the build material composition from the build material supply. The build area platform may be moved in various directions so that the build material composition may be delivered to the build area platform or to a previously formed layer. In an example, when the build material composition is to be delivered, the build area platform may be programmed to advance (e.g., downward or in the Z direction relative to the X-Y plane of the build area platform) enough so that the build material distributor can push the build material composition onto the build area platform to form a substantially uniform layer of the build material composition thereon. The build area platform may also be returned to its original position, for example, when a new part is to be built.

The build material supply may be a container, bed, or other surface that is to position the build material composition between the build material distributor and the build area platform. The build material supply may include heaters so that the build material composition is heated to a supply temperature ranging from about 25° C. to about 200° C. In these examples, the supply temperature may depend, in part, on the build material composition used and/or the 3D printer used. As such, the range provided is one example, and higher or lower temperatures may be used.

The build material distributor may be moved in various directions, over the build material supply and across the build area platform to spread the layer of the build material composition over the build area platform. The build material distributor may also be returned to a position adjacent to the build material supply following the spreading of the build material composition. The build material distributor may be a blade (e.g., a doctor blade), a roller, a combination of a roller and a blade, and/or any other device capable of spreading the build material composition over the build area platform. For instance, the build material distributor may be a counter-rotating roller. In some examples, the build material supply or a portion of the build material supply may translate along with the build material distributor such that build material composition is delivered continuously to the build area platform.

The build material supply may supply the build material composition into a position so that it is ready to be spread onto the build area platform. The build material distributor may spread the supplied build material composition onto the build area platform. The controller may process “control build material supply” data, and in response, control the build material supply to appropriately position the particles of the build material composition, and may process “control spreader” data, and in response, control the build material distributor to spread the build material composition over the build area platform to form the layer.

The build material layer has a substantially uniform thickness across the build area platform. In an example, the build material layer has a thickness ranging from about 50 μm to about 120 μm. In another example, the thickness of the build material layer ranges from about 30 μm to about 300 μm. It is to be understood that thinner or thicker layers may also be used. For example, the thickness of the build material layer may range from about 20 μm to about 500 μm. The layer thickness may be about 2× (i.e., 2 times) the average diameter of the polymeric material at a minimum for finer part definition. In some examples, the layer thickness may be about 1.2× the average diameter of the polymeric material in the build material composition.

After the build material composition has been applied, and prior to further processing, the build material layer may be exposed to heating. In an example, the heating temperature may be below the melting point or melting range of the polymeric material in the build material composition. As examples, the pre-heating temperature may range from about 5° C. to about 50° C. below the melting point or the lowest temperature of the melting range of the polymeric material. In an example, the pre-heating temperature ranges from about 50° C. to about 205° C. In still another example, the pre-heating temperature ranges from about 100° C. to about 190° C. It is to be understood that the pre-heating temperature may depend, in part, on the build material composition used. As such, the ranges provided are some examples, and higher or lower temperatures may be used.

Pre-heating the layer may be accomplished by using any suitable heat source that exposes all of the build material composition in the build material layer to the heat. Examples of the heat source include a thermal heat source (e.g., a heater integrated into the build area platform (which may include sidewalls)) or a radiation source. After the build material layer is formed, and in some instances is pre-heated, the fusing agent is selectively applied on at least a portion of the build material composition in the layer to form a patterned portion.

The amount of the fusing agent that is applied per unit of the build material composition in the patterned portion may be sufficient to absorb and convert enough energy so that the build material composition in the patterned portion will coalesce. The amount of the fusing agent that is applied per unit of the build material composition may depend, at least in part, on the loading of the IR absorbing pigment in the fusing agent, and the polymeric material in the build material composition. In particular, the concentration of the visible light absorbing pigment in the fusing agent can be considered. This concentration can be used to determine how much fusing agent to apply to achieve a weight ratio of fusing agent to build material composition for acceptable layer-by-layer fusing. If applying the fusing agent to the build material composition at about a 1:9 weight ratio, then the visible light absorbing pigment to build material composition weight ratio (as applied) can be from about 3:900 to about 15:900. If more or less of the fusing agent is applied to the build material composition, then these ratios can be adjusted accordingly.

The printing system further includes a first applicator coupled to a first supply, which contains the fusing agent. The fusing agent may be dispensed from the first applicator during printing. The applicator may include a thermal inkjet printhead, a piezoelectric printhead, a continuous inkjet printhead, etc. in fluid communication with the first supply (which is a fluid reservoir/container), and the selective application of the fusing agent may be accomplished by thermal inkjet printing, piezo electric inkjet printing, continuous inkjet printing, etc. The controller may process data, and in response, control the first applicator to deposit the fusing agent onto predetermined portion(s) of the build material composition to generate the patterned portion.

In some examples, the method further comprises selectively applying, based on the 3D object model, the detailing agent onto another portion of the build material layer outside of the patterned portion. The detailing agent may be selectively applied to the portion(s) of the layer that are not patterned with the fusing agent, and thus that are not to become part of a final 3D object layer. Thermal energy generated during radiation exposure may propagate into the surrounding portion(s) that do not have the fusing agent applied thereto. The propagation of thermal energy may be inhibited and, in turn, the coalescence of the non-patterned build material portion(s) may be prevented when the detailing agent is applied to these other portion(s).

In some other examples, the detailing agent may also or alternatively be applied to the patterned portion or a portion of the patterned portion (i.e., with the fusing agent). The detailing agent may be applied to the patterned portion to provide a cooling effect so that the build material does not overheat and/or to lower the extent of fusing in the area patterned with both the fusing agent and the detailing agent. In these examples, the amount of the detailing agent that is applied should be low enough so that fusing is not completely inhibited. In other examples, the detailing agent and the fusing agent may intermingle at the edge(s) between the patterned portion and the other portion(s).

The detailing agent may be dispensed from a second applicator. The second applicator may include a thermal inkjet printhead, a piezoelectric printhead, a continuous inkjet printhead, etc. in fluid communication with a third supply (which may be a fluid reservoir/container) containing the detailing agent, and the selective application of the detailing agent may be accomplished by thermal inkjet printing, piezo electric inkjet printing, continuous inkjet printing, etc. The controller may process data, and in response, control the second applicator to deposit the detailing agent onto predetermined portion(s) of the build material composition to generate the portion(s).

It is to be understood that the selective application of any of the fusing agent and/or the detailing agent may be accomplished in a single printing pass or in multiple printing passes. In some examples, the agent(s) is/are selectively applied in a single printing pass. In some other examples, the agent(s) is/are selectively applied in multiple printing passes. In one of these examples, the number of printing passes used for each of the agents ranges from 2 to 4. Applying the fusing agent and/or the detailing agent in multiple printing passes may help to increase the amount that is applied to the build material composition, to avoid liquid splashing, to avoid displacement of the build material composition, etc.

After the fusing agent and/or detailing agent are selectively applied in the specific portion(s) of the layer, the entire layer of the build material composition is exposed to electromagnetic radiation in the form of visible light. The electromagnetic radiation is emitted from a visible light source. The radiation source may include visible light lamps, visible light emitting diodes (LEDs), or another broad-spectrum light source emitting the suitable visible light wavelength(s). The length of time the electromagnetic radiation is applied for, or energy exposure time, may be dependent, for example, on: characteristics of the radiation source; characteristics of the build material composition; and/or characteristics of the fusing agent. In an example, a single point of the build material layer is exposed to electromagnetic radiation for a period of time ranging from 0.01 second to 1 second.

It is to be understood that the electromagnetic radiation exposure may be accomplished in a single radiation event or in multiple radiation events. The term “event,” as used herein, refers to one period of exposure of electromagnetic radiation from the radiation source. In an example, a radiation event may occur as a pass of a moveable radiation source over the build material layer (similar to a printing pass). In an example, the exposing of the build material composition is accomplished in multiple radiation events. In a specific example, the number of radiation events ranges from 1 to 8. In still another specific example, the exposure of the build material composition to electromagnetic radiation may be accomplished in 3 radiation events. Exposing the build material composition to electromagnetic radiation in multiple radiation events may help to counteract a cooling effect that may be brought on by the amount of the fusing agent, alone or in combination with the detailing agent, that is applied to the build material layer. Additionally, exposing the build material composition to electromagnetic radiation in multiple radiation events may help to sufficiently elevate the temperature of the build material composition in the portion(s) without overheating the build material composition in the non-patterned portion(s).

The fusing agent enhance(s) the absorption of the visible light radiation, converts the absorbed visible light radiation to thermal energy, and promotes the transfer of the thermal heat to the build material composition in contact therewith. In an example, the fusing agent sufficiently elevates the temperature of the build material composition in the portion to a temperature above the melting point or within the melting range of the polymeric material, allowing coalescing/fusing (e.g., thermal merging, melting, binding, etc.) of the build material composition to take place. The application of the electromagnetic radiation forms the 3D object layer.

In an example, the electromagnetic radiation has a wavelength ranging from 400 nm to 700 nm. Radiation having wavelengths within the provided ranges may be substantially absorbed (e.g., 80% or more of the applied radiation is absorbed) by the fusing agent and may heat the build material composition in contact therewith. Further, the radiation may not be substantially absorbed (e.g., 25% or less of the applied radiation is absorbed) by the non-patterned build material composition in portion(s).

After the 3D object layer is formed, additional layer(s) may be formed thereon to create an example of the 3D printed object. To form the next layer, additional build material composition may be applied on the layer. The fusing agent is then selectively applied on at least a portion of the additional build material composition, according to the 3D object model. The detailing agent may be applied in any area of the additional build material composition where coalescence is not to take place or where the extent of fusing is to be reduced. After the fusing agent and/or detailing agent is/are applied, the entire additional layer of the additional build material composition is exposed to electromagnetic radiation in the manner described herein. The application of additional build material composition, the selective applications of the fusing agent, alone or in combination with the detailing agent, and the electromagnetic radiation exposure may be repeated for a predetermined number of cycles to form the final 3D printed part in accordance with the 3D object model. As such, some examples of the method include repeating the applying of the build material composition, the selectively applying of the fusing agent, and the exposing, to form a predetermined number of 3D part layers and a 3D printed part.

In the examples disclosed herein, a 3D part may be printed in any orientation. For example, the 3D part can be printed from bottom to top, top to bottom, on its side, at an angle, or any other orientation. The orientation of the 3D part can also be formed in any orientation relative to the layering of the build material composition. For example, the 3D part can be formed in an inverted orientation or on its side relative to the layering of the build material composition. The orientation of the build within each layer can be selected in advance or even by the user at the time of printing, for example.

Examples of the method described herein may be used to generate individual 3D part or object layers that make up a three-dimensional (3D) printed object/part. Details of the 3D printed part are provided below.

### 3D Printed Part

The 3D printed part formed by the 3D printing method described above is a colored part and may be referred to as a “colored 3D printed part.” The colored 3D printed part exhibits a color of the visible light absorbing pigment used in the fusing agent. By “exhibits a color,” it is meant that the 3D printed object being referred to closely resembles the color of the visible light absorbing pigment included in the fusing agent.

The colored 3D printed part includes coalesced polymeric build material (e.g., coalesced thermoplastic polyamide), a residual amount of the plasticizing solvent package present in the coalesced polymeric build material, and a pigment embedded in the coalesced polymeric build material. The pigment is the same pigment used in the fusing agent and can be an anthraquinone, a phthalocyanine blue, phthalocyanine green, an azo, a quinophthalone, a perylene, a quinacridone, or a (thio) indigoid. Specific examples of these pigments are described above.

The 3D printed part includes a plurality of build material layers of coalesced polymeric build material. In a particular example, the 3D printed part includes a plurality of build material layers of coalesced thermoplastic polyamide. While most of the solvents (e.g., the aromatic alcohol) of the plasticizing solvent package used in the fusing agent are evaporated during printing, a residual amount of the solvent(s) of the plasticizing solvent package is/are likely to remain. In an example, greater than 0 wt % and less than 3 wt % of the solvent(s) of the plasticizing solvent package remain in the 3D printed part.

Additionally, at least most, if not all, of the visible light absorbing pigment deposited during 3D printing remains in the 3D printed part. In an example, all (i.e., 100%) of the deposited visible light absorbing pigment remains in the 3D printed part, embedded in the coalesced polymeric build material. Because at least most of the deposited visible light absorbing pigment remains, the 3D printed part exhibits the color of the pigment. For instance, if the fusing agent used to form the part includes PY 74 pigment, the 3D printed part will exhibit the color of the PY 74 pigment, which is a yellow color.

It is to be understood that other components of the build material composition (e.g., whitener, etc.) and/or components of the fusing agent that do not evaporate may also be present in the 3D printed part. The weight percentage of each component may depend on the amount used in the build material composition and/or the fusing agent, the dimensions of the 3D printed part, the amount of the fusing agent applied, the evaporation rate (if any) of the components, and other like conditions or parameters.

To further illustrate the present disclosure, examples are given herein. It is to be understood that these examples are provided for illustrative purposes and are not to be construed as limiting the scope of the present disclosure.

### Examples

### Fusing Agent Including a Visible Light Pigment

A sample fusing agent was prepared. The sample fusing agent, FA, included a Pigment Yellow 74 (PY 74) dispersion, containing 13.5 wt % active of the dispersed yellow pigment. The formulation of the sample fusing agent, FA, is set forth in Table 2 below:

TABLE 2

| Component of FA | % active | wt % in FA |
|---|---|---|
| HE2P | 100 | 42.00 |
| PY 74 Dispersion | 13.5 | 1.0 |
| benzyl alcohol | 100 | 13.00 |
| TERGITOL ® 15-S-9 | 100 | 0.70 |
| Water | 100 | Balance |

The sample fusing agent FA exhibited an intense yellow color, and the fusing agent could be activated by radiation exposure from a blue LED or a laser of sufficient power during 3D printing.

### Comparative Fusing Agent Including a Visible Light Dye

A comparative fusing agent was also prepared. The comparative fusing agent, CFA, had the same formulation as the sample fusing agent FA set forth in Table 2 except that the PY 74 dispersion was replaced with Acid Yellow 73 (AY 73) dye. The formulation of the comparative fusing agent, CFA, is set forth in Table 3 below:

TABLE 3

| Component of CFA | % active | wt % in FA |
|---|---|---|
| HE2P | 100 | 42.00 |
| AY 73 | 100 | 1.0 |
| benzyl alcohol | 100 | 13.00 |
| TERGITOL ® 15-S-9 | 100 | 0.70 |
| Water | 100 | Balance |

The comparative fusing agent CFA exhibited an intense yellow color. Similar to the sample fusing agent FA, the comparative fusing agent CFA could be activated by radiation exposure from a blue LED or a laser of sufficient power during 3D printing.

### Formation of Coupons and Dog Bones

Coupons 1 and 2 were printed, in a layer-by-layer fashion as described herein, using a thermoplastic polyamide powder as the build material. One of the coupons, Coupon 1, was printed using the sample fusing agent FA, and another one of the coupons, Coupon 2, was printed using the comparative fusing agent CFA. For both of the Coupons 1 and 2, the 3D printing was accomplished using a powder to fusing agent mass ratio of about 95:5. The Coupons 1 and 2 were each formed having a thickness of about 1.5 mm.

Coupons 3 and 4 were printed, in a layer-by-layer fashion as described herein, respectively using polyamide 12 and a thermoplastic polyamide powder as the build material. Both Coupons 3 and 4 were printed using the comparative fusing agent CFA. For both of the Coupons 3 and 4, the 3D printing was accomplished using a powder to fusing agent mass ratio of about 95:5. The Coupons 3 and 4 were each formed having a thickness of about 1.5 mm.

Dog bones were also printed, in a layer-by-layer fashion as described herein, respectively using the thermoplastic polyamide powder as the build material. The dog bones were printed using the sample fusing agent FA. For the dog bones, the 3D printing was accomplished using a powder to fusing agent mass ratio of about 95:5. The dog bones were each formed having a thickness of about 1.5 mm.

### Testing of Coupons

Coupons 1 and 2 were both tested for fade resistance by subjecting the Coupons 1 and 2 to continuous, high intensity, simulated sunlight irradiation in a Q-SUN Xenon Arc Tester (Model VE-3HC, available from Q-Lab, Westlake, OH) for multiple days. The test conditions were as follows: 40° C. and 40% relative humidity. The Coupons 1 and 2 were periodically inspected during the testing.

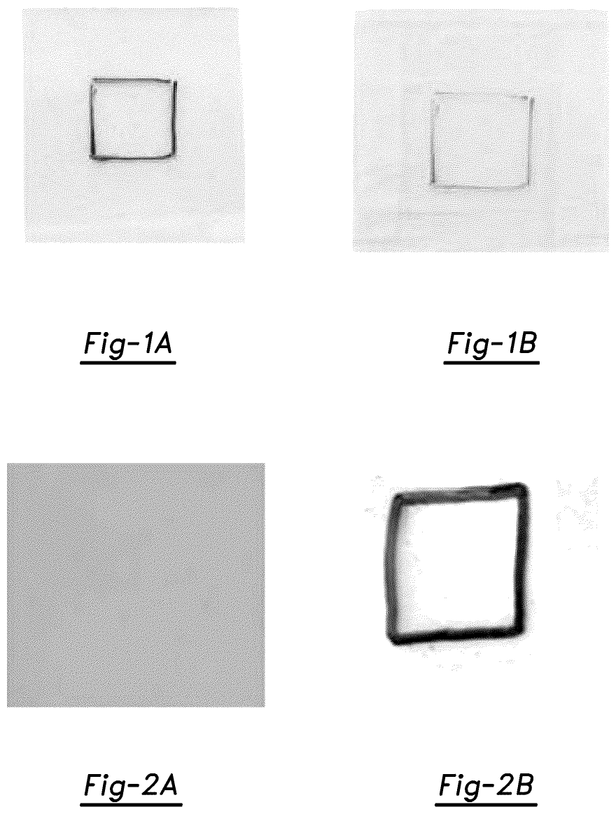

Photographs of Coupons 1 and 2 that were taken prior to subjecting the coupons to the sunlight irradiation are shown in FIGS. 1A and 2A, respectively. Both of the Coupons 1 and 2, prior to sunlight irradiation, exhibited a yellow color.

Photographs of Coupons 1 and 2 were taken after subjecting the coupons to long term sunlight irradiation, and are shown in FIGS. 1B and 2B, respectively. As can be seen in FIG. 1B, Coupon 1 retained its yellow color after 109 hours of sunlight exposure. However, as can be seen in FIG. 2B, Coupon 2 completely faded to a whiteish color after 24 hours of sunlight exposure. These results show that Coupon 1, formed using the yellow pigment dispersion, exhibited superior fade resistance (i.e., has excellent lightfastness) when exposed to long term sunlight irradiation compared to Coupon 2, which was formed using the fusing agent containing the yellow dye.

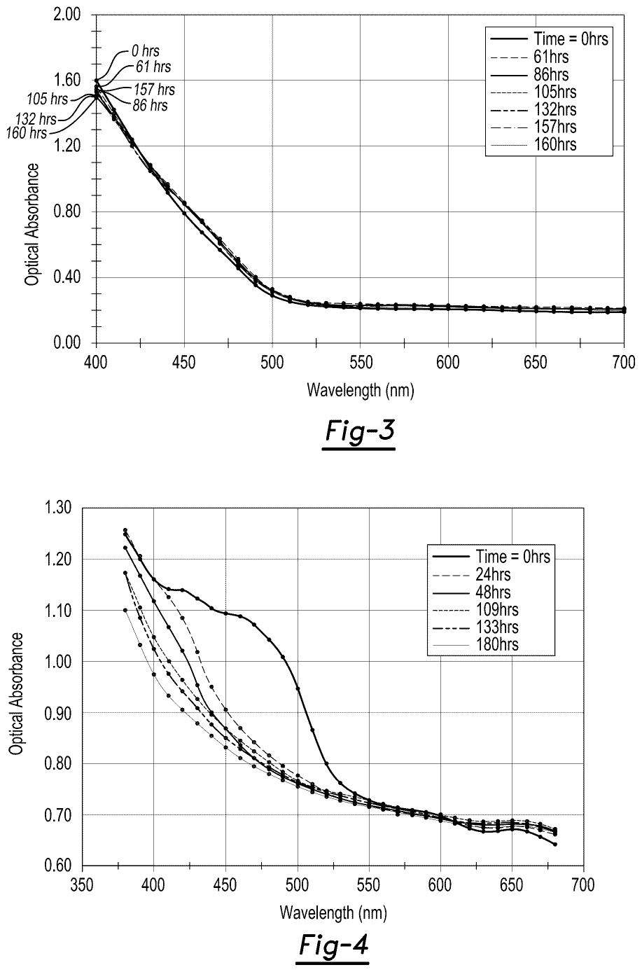

The optical absorbance spectrum of Coupons 1 and 2 was monitored using a spectrophotometer. The absorbance spectra of Coupons 1 and 2 are shown in FIGS. 3 and 4, respectively. The spectra affirm the lightfastness results of FIG. 1A through FIG. 2B, whereby the absorbance spectrum of Coupon 2 (which was formed using the comparative fusing agent including the yellow dye) underwent dramatic changes during the first 24 hours of sunlight irradiation exposure. The absorbance spectrum of Coupon 1 (which was formed using the sample fusing agent including the yellow pigment dispersion), on the other hand, remained practically unchanged throughout the duration of the sunlight irradiation exposure.

### Testing of Coupons and Dog Bones

Coupons 3 and 4 and the dog bones were exposed to sunlight irradiation. The optical density of each of the Coupons 3 and 4 was measured using an X-Rite calorimeter (available from X-Rite, Inc, Grand Rapids, MI) at the following hours of exposure: 0, 4, 24, and 48 hours. The optical density of each of the dog bones was also measured using the X-Rite calorimeter at the following hours of exposure: 0, 61, 86, 105, 132, 157, and 160 hours. The change in optical density from 0 hours to the given exposure time was calculated, as was the % optical density loss. The results are shown in Table 4 below.

TABLE 4

| | Coupon 3 | | | Coupon 4 | | |
|---|---|---|---|---|---|---|
| Dye Xenon Arc | Yellow | Delta | % OD | Yellow | Delta | % OD |
| Exposure (hr) | OD | OD | loss | OD | OD | loss |
| AY73_0 hr | 1.1554 | | | 1.2894 | | |
| AY73_4 hr | 0.8722 | 0.28 | 25% | 0.8722 | 0.42 | 32% |
| AY73_24 hr | 0.6624 | 0.49 | 43% | 0.6624 | 0.63 | 49% |
| AY73_48 hr | 0.6119 | 0.54 | 47% | 0.6119 | 0.68 | 53% |

| | | | | TPA dog bone samples | | |
|---|---|---|---|---|---|---|
| Pigment Xenon | Yellow | Delta | % OD | Yellow | Delta | % OD |
| Arc Exposure (hr) | OD | OD | loss | OD | OD | loss |
| PY74_0 hr | | | | 0.69 | | |
| PY74_61 hr | | | | 0.71 | −0.02 | −3% |
| PY74_86 hr | | | | 0.71 | −0.01 | −2% |
| PY74_105 hr | | | | 0.70 | −0.01 | −1% |
| PY74_132 hr | | | | 0.70 | −0.01 | −1% |
| PY74_157 hr | | | | 0.67 | 0.02 | 3% |
| PY74_160 hr | | | | 0.68 | 0.01 | 2% |

The results shown in Table 4 illustrate that the optical density loss for the dog bones formed with the sample fusing agent FA was significantly less that that observed for either type of coupon formed with the comparative fusing agent CFA, again confirming that the pigment based fusing agent imparts better light fastness than the dye based fusing agent.

### Additional Notes

It is to be understood that the ranges provided herein include the stated range and any value or sub-range within the stated range. For example, from about 0.1 wt % active to about 10 wt % active should be interpreted to include not only the explicitly recited limits of from about 0.1 wt % active to about 10 wt % active, but also to include individual values, such as about 3.25 wt % active, about 4 wt % active, about 8 wt % active, about 9.5 wt % active, etc., and sub-ranges, such as from about 5 wt % active to about 10 wt % active, from about 4.5 wt % active to about 8.5 wt % active, from about 3 wt % active to about 8 wt % active, etc.

Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A three-dimensional printing kit, comprising:
a fusing agent including:
a visible light absorbing pigment present in an amount ranging from about 0.1 wt % active to about 10 wt % active, based on a total weight of the fusing agent;
a plasticizing solvent package consisting of:
i) from about 40 wt % active to 60 wt % active of propylene glycol, based on the total weight of the fusing agent; or
ii) from about 1 wt % active to about 20 wt % active of an aromatic alcohol and from about 5 wt % active to 50 wt % active of a plasticizing solvent that increases water solubility of the aromatic alcohol, based on the total weight of the fusing agent; or
iii) from about 10 wt % active to about 30 wt % active of propylene glycol, from about 5 wt % active to about 20 wt % active of an aromatic alcohol, and from about 5 wt % active to 50 wt % active, based on the total weight of the fusing agent, of a plasticizing solvent that increases water solubility of the aromatic alcohol; and
a balance of water; and
a polymeric build material composition including a thermoplastic polyamide.

2. The three-dimensional printing kit as defined in claim 1, wherein:
the plasticizing solvent package consists of the aromatic alcohol and the plasticizing solvent;
the aromatic alcohol is selected from the group consisting of benzyl alcohol and 2-phenoxyethanol; and
the plasticizing solvent is selected from the group consisting of 1-(2-hydroxyethyl)-2-pyrrolidone (HE2P), isopropylidene glycerol, poly (ethylene glycol) 300, and glycerol.

3. The three-dimensional printing kit as defined in claim 1, wherein:
the plasticizing solvent package consists of propylene glycol, the aromatic alcohol, and the plasticizing solvent;
the aromatic alcohol is selected from the group consisting of benzyl alcohol and 2-phenoxyethanol; and
the plasticizing solvent is selected from the group consisting of 1-(2-hydroxyethyl)-2-pyrrolidone (HE2P), isopropylidene glycerol, poly (ethylene glycol) 300, and glycerol.

4. The three-dimensional printing kit as defined in claim 1, wherein the fusing agent further includes a surfactant present in an amount ranging from about 0.05 wt % active to about 1 wt % active, based on a total weight of the fusing agent.

5. The three-dimensional printing kit as defined in claim 1, wherein the fusing agent further includes a styrene acrylic dispersant.

6. The three-dimensional printing kit as defined in claim 5, wherein the styrene acrylic dispersant is present in the fusing agent in an amount ranging from about 0.01% to about 3%, based on a total mass of the pigment in the fusing agent.

7. The three-dimensional printing kit as defined in claim 1, wherein the visible light absorbing pigment is selected from the group consisting of an anthraquinone, a phthalocyanine blue, phthalocyanine green, an azo, a quinophthalone, a perylene, a quinacridone, and a (thio) indigoid.

8. The three-dimensional printing kit as defined in claim 7, wherein:
the visible light absorbing pigment is selected from the group consisting of the azo and the quinophthalone; and
when the visible light absorbing pigment is the azo, the azo is selected from the group consisting of Pigment Yellow (PY) 74 and PY 117; or
when the visible light absorbing pigment is the quinophthalone, the quinophthalone is PY 138.

9. The three-dimensional printing kit as defined in claim 7, wherein:
the visible light absorbing pigment is the phthalocyanine blue; and
the phthalocyanine blue is copper phthalocyanine blue or a derivative thereof.

10. The three-dimensional printing kit as defined in claim 7, wherein:
the visible light absorbing pigment is selected from the group consisting of the anthraquinone, the perylene, the quinacridone, and the (thio) indigoid; and
when the visible light absorbing pigment is the anthraquinone, the anthraquinone is selected from the group consisting of Pigment Red (PR) 43, PR 194, PR 216, PR 226, and combinations thereof; or
when the visible light absorbing pigment is the perylene, the perylene is PR 123, PR 149, PR 179, PR 190, PR 189, PR 224, and combinations thereof; or
when the visible light absorbing pigment is the quinacridone, the quinacridone is selected from the group consisting of pigment orange (PO) 48, PO 49, PR 122, PR 192, PR 202, PR 206, PR 207, PR 209, pigment violet (PV) 19, PV 42, and combinations thereof; or
when the visible light absorbing pigment is the (thio) indigoid, the (thio) indigoid is PR86, PR87, PR88, PR181, PR198, PV36, PV38, or combinations thereof.

11. A method for using the kit of claim 1, comprising:
generating a lightfast 3D printed part containing multiple fused layers, each of the multiple fused layers being formed by:
forming a layer of the polymeric build material composition;
based on a 3D object model, selectively applying the fusing agent to the layer; and
exposing the layer to visible light.

12. A 3D printed part, comprising:
coalesced thermoplastic polyamide;
a residual amount of a plasticizing solvent package present in the coalesced thermoplastic polyamide; and
a pigment embedded in the coalesced thermoplastic polyamide, the pigment being selected from the group consisting of an anthraquinone, a phthalocyanine blue, phthalocyanine green, an azo, a quinophthalone, a perylene, a quinacridone, and a (thio) indigoid.

13. The 3D printed part as defined in claim 12, wherein:
the pigment is selected from the group consisting of the azo and the quinophthalone; and
when the pigment is the azo, the azo is selected from the group consisting of Pigment Yellow (PY) 74 and PY 117; or
when the pigment is the quinophthalone, the quinophthalone is PY 138.

14. The 3D printed part as defined in claim 12, wherein:
the pigment is the phthalocyanine blue; and
the phthalocyanine blue is copper phthalocyanine blue or a derivative thereof.

15. The 3D printed part as defined in claim 12, wherein:
the pigment is selected from the group consisting of the anthraquinone, the perylene, the quinacridone, and the (thio) indigoid; and
when the pigment is the anthraquinone, the anthraquinone is selected from the group consisting of Pigment Red (PR) 43, PR 194, PR 216, PR 226, and combinations thereof; or
when the pigment is the perylene, the perylene is PR 123, PR 149, PR 179, PR 190, PR 189, PR 224, and combinations thereof; or
when the pigment is the quinacridone, the quinacridone is selected from the group consisting of pigment orange (PO) 48, PO 49, PR 122, PR 192, PR 202, PR 206, PR 207, PR 209, pigment violet (PV) 19, PV 42, and combinations thereof; or
when the pigment is the (thio) indigoid, the (thio) indigoid is PR86, PR87, PR88, PR181, PR198, PV36, PV38, or combinations thereof.
